(19) United States
(12) Patent Application Publication
(10) Pub. No.: US 2023/0363059 A1
(43) Pub. Date: Nov. 9, 2023

(54) INTELLIGENT CUP WARMER

(71) Applicant: Guangzhou Yona Import and Export Co., Ltd., Guangzhou (CN)

(72) Inventor: JINGEN HE, Guangzhou (CN)

(21) Appl. No.: 18/351,646

(22) Filed: Jul. 13, 2023

(51) Int. Cl. H05B 1/02; H05B 3/68

(52) U.S. Cl. CPC H05B 1/0202; H05B 1/0269; H05B 3/68; H05B 2203/02; H05B 2203/021

(57) ABSTRACT

A protective case of a intelligent cup warmer includes a shell, a control circuit board, a heating device a thermal conductive tray, and a touch sensing switch. The thermal conductive tray is disposed on an upper side of the shell. The shell includes an installation chamber for accommodating the heating device and the control circuit board. An upper surface of the thermal conductive tray is configured to heat cups, a bottom surface of the thermal conductive tray are connected the heating device. The touch sensing switch includes a touch sensing area disposed on the shell, integrated with the shell and formed with the shell in the same molding process. The induction element is disposed between the touch sensing area and the control circuit board, one end of the induction element is in connected to the touch sensing area, and the other end is electrically connected to the control circuit board.

### FIELD

The present disclosure relates to the field of home appliance, in particular, to an intelligent cup warmer.

### BACKGROUND

Current cup warmers use mechanical button switches or piano key switches, which are noisy. Moreover, due to the easy wear and dirt accumulation of the button parts, the switch service life is short, and some buttons are not waterproof, which can easily burn out the cup warmer circuit.

### SUMMARY

The present disclosure provides an intelligent cup warmer using touch sensing switch to reduce mechanical operation of the switch buttons and noise, and the touch sensing switch is waterproof and leakage proof, reducing switch damage, thereby extending the service life of the intelligent cup warmer. The corresponding sensing area is also provided with LED lights, increasing a backlight effect and improving user experience. The overall structure of the intelligent cup warmer is reasonable, compact, and simple, making it easy to assemble and disassemble.

The present disclosure provides an intelligent cup warmer including a shell, a control circuit board, a heating device a thermal conductive tray, and a touch sensing switch, wherein the thermal conductive tray is disposed on an upper side of the shell, the shell includes an installation chamber for accommodating the heating device and the control circuit board, an upper surface of the thermal conductive tray is configured to heat cups, a bottom surface of the thermal conductive tray are connected the heating device, the touch sensing switch includes a touch sensing area disposed on the shell, integrated with the shell and formed with the shell in the same molding process, the induction element is disposed between the touch sensing area and the control circuit board, one end of the induction element is in connected to the touch sensing area, and the other end is electrically connected to the control circuit board.

Further, the intelligent cup warmer includes an LED light disposed between the control circuit board and the touch sensing area and configured for emitting induction lights, the induction element is a flat top spring surrounding the LED light and connected between the touch sensing area and the control circuit board

Further, the heating device is fixedly connected to the shell, electrically connected the control circuit board, contacted with the bottom surface of the thermal conductive tray, the heating device is configured to transmit heat to the thermal conductive tray.

Further, the intelligent cup warmer further includes a temperature detection device configured to detect a temperature of the heating device, the control circuit board is configured to control a temperature of the heating device based on the temperature detected by the temperature detection device, the temperature detection device includes a temperature detection head connected to the heating device, and the temperature detection device is electrically connected to the control circuit board.

Further, the temperature detection device includes an NTC temperature sensor.

Further, the heating device includes a installation frame and a heating plate, and the installation frame is fixedly connected to the shell, the installation frame is provided with a first installation opening, and the heating plate is clamped and arranged inside the first installation opening, the heating plate is electrically connected to the control circuit board, and the heating plate is connected to a lower surface of the thermal conductive tray for transmitting heat to the thermal conductive tray.

Further, the heating plate includes a PTC heating plate.

Further, the heating plate is electrically connected to the control circuit board through a first wire and a second wire, a first end of the first wire and a first end of the second wire are detachably connected to the control circuit board, a second end of the first wire is connected to the heating plate, a second end of the second wire is electrically connected to the temperature detection device, the heating plate is electrically connected to the control circuit board through the first wire, and the control circuit board is electrically connected to the temperature detection device through the second wire.

Further, two sides of the first installation opening is provided with clamping pieces, and a positioning groove is formed between the two clamping pieces, the heating plate is provided with at least one positioning protrusion, when the installation frame is fixedly connected to the shell and the positioning protrusion is disposed in the positioning groove, and the clamping pieces press the heating plate onto the thermal conductive tray tightly.

Further, both the first end of the first wire and the first end of the second wire are provided with a connector, and the connector includes a female terminal and a male terminal, the female terminal is fixed on the control circuit board, the male terminal is set at the first end of the wire, and the female terminal and the male terminal are detachably connected.

Further, a plurality of first installation holes are disposed on the installation frame, a plurality of first installation pillar corresponding to the first installation holes are provided on the shell, and a plurality of second installation holes corresponding to the first installation holes are provided on the first installation pillar respectively, the first installation holes are connected to the corresponding second installation holes through a plurality of bolts to fix the installation frame on the shell, and the installation frame is configured to fix and connect the thermal conductive tray.

Further, the shell includes a bottom shell and an upper shell, the bottom shell is provided with a plurality of second installation pillars, the upper shell is provided with an installation groove corresponding to the second installation pillar, the installation groove is clamped with the second installation pillar to ensure the bottom shell and the upper shell cover each other, the upper shell is provided with a second installation opening, and the thermal conductive tray is installed at the second installation opening.

Further, a plurality of heat dissipation holes is provided on a bottom of the bottom shell.

Further, a plurality of anti slip pads are provides on a bottom of the bottom shell, the anti slip pads are configured to raise the intelligent cup warmer, so that when the intelligent cup warmer is placed on a platform, there is a gap between the intelligent cup warmer and the platform, and when a heating plate emits heat, the heat emitted by the heating plate disperses through the heat dissipation holes and the gap.

Further, the touch sensing area includes a temperature control sensing key area and a temperature timing sensing key area, the sensing element includes a temperature control sensing element and a timing sensing element, the temperature control sensing element is arranged between the temperature control sensing key area and the control circuit board, and one end of the temperature control sensing element connects with the temperature control sensing key area, the other end of the temperature control sensing element is arranged on the control circuit board, the timing sensing element is arranged between the temperature timing sensing key area and the control circuit board, one end of the timing sensing element is in contact with the temperature timing sensing key area, and the other end of the timing sensing element is arranged on the control circuit board.

Further, the intelligent cup warmer includes five different heating temperatures ranging from 110° C. to 170° C.

Further, the five different heating temperatures are 110° C., 130° C., 150° C., 165° C., and 170° C.

Further, the intelligent cup warmer includes three automatic shutdown functions for there different heating times, the three different heating times are two hours, four hours and eight hours.

Further, the intelligent cup warmer includes a power cord, one end of the power cord is connected to the control circuit board, and a plug is disposed on the other end of the power cord.

The beneficial effects of the present disclosure lie in: the structure of the intelligent cup warmer of this embodiment is compact and simple. Compared to the existing cup warmers, the intelligent cup warmer of this embodiment with the touch sensing switch is preferable in waterproof and intelligence. It also has three automatic shutdown functions for there different heating times. and five different temperature setting, and there is also an LED light for emitting lights during temperature adjusting, providing a better user experience.

### BRIEF DESCRIPTION OF THE DRAWINGS

In order to explain the technical solutions of the embodiments of the present disclosure more clearly, the following will briefly introduce the accompanying drawings used in the embodiments. Apparently, the drawings in the following description are only some embodiments of the present disclosure. Those of ordinary skill in the art can obtain other drawings based on these drawings without creative work.

The present disclosure is further described below in detail in combination with the accompanying drawings and embodiments.

FIG. 1 is a schematic diagram of an overall structure of the present disclosure.

FIG. 2 is an exploded diagram of an intelligent cup warmer without an upper shell of the present disclosure.

FIG. 3 is a schematic diagram of a bottom shell of the intelligent cup warmer of the present disclosure.

FIG. 4 is a bottom view of the bottom shell of the intelligent cup warmer of the present disclosure.

FIG. 5 is a schematic diagram of an installation frame of the intelligent cup warmer of the present disclosure.

FIG. 6 is a top view of the upper shell of the intelligent cup warmer of the present disclosure.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the said features. In the description of embodiments of the application, “a plurality of” means two or more, unless otherwise specifically defined.

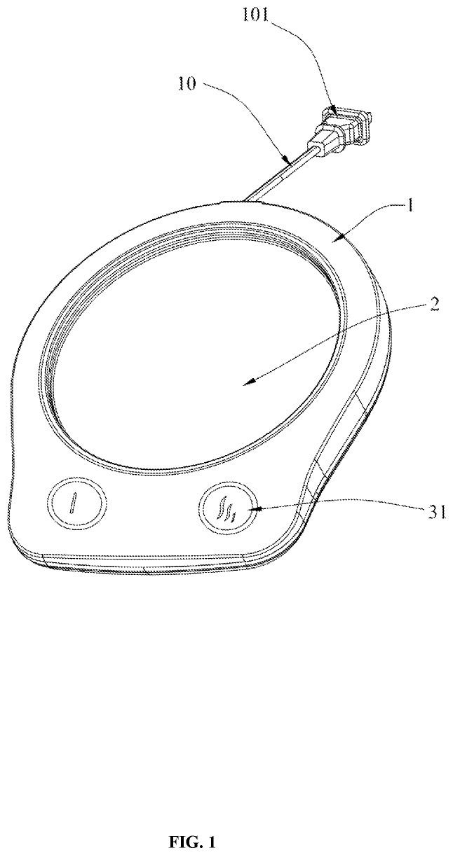

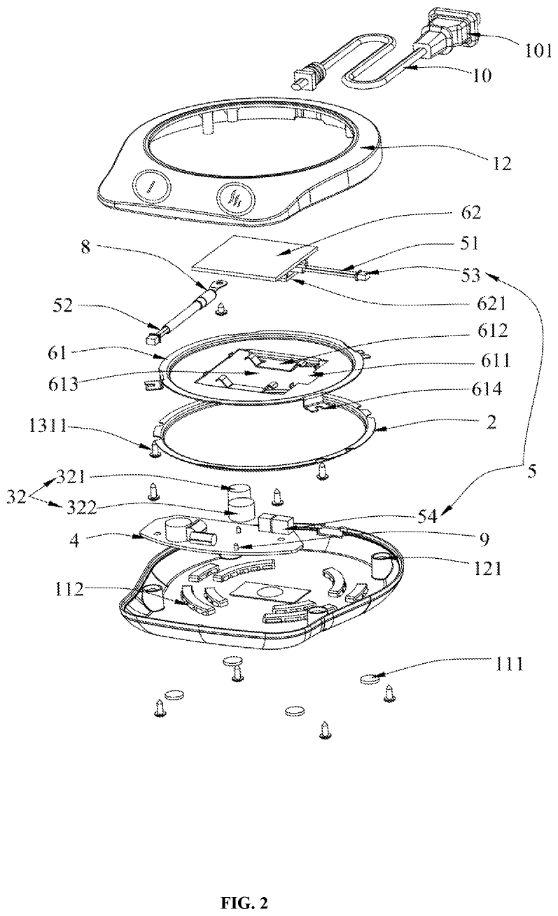

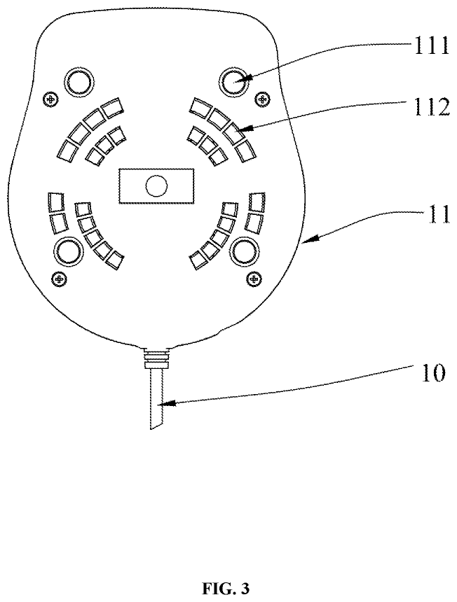

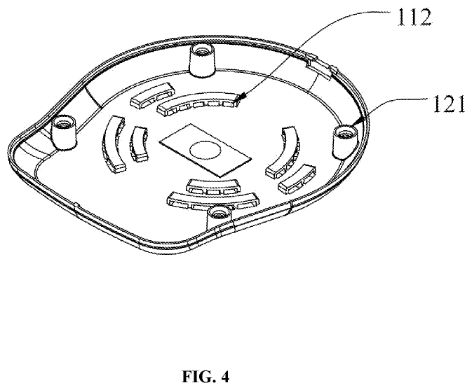

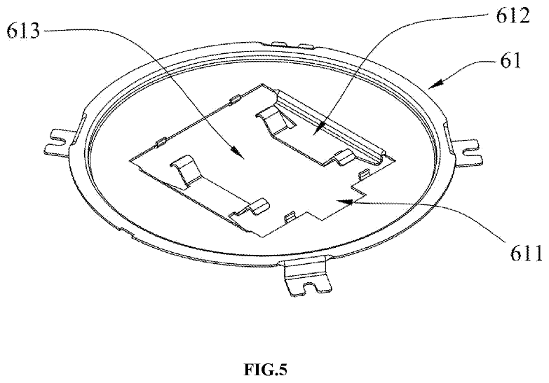

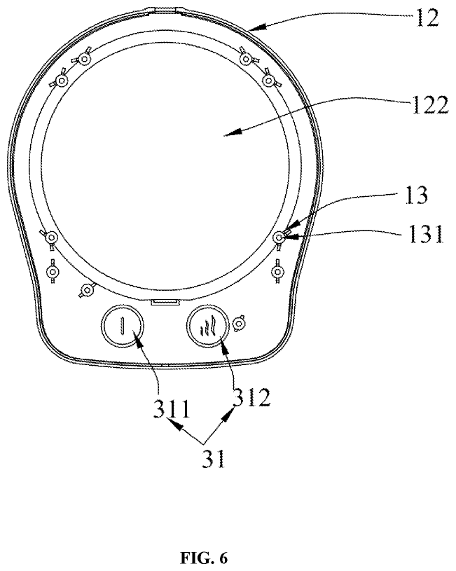

Referring to FIG. 1 to FIG. 6, an intelligent cup warmer includes a shell 1 and a touch sensing switch. An upper side of the shell 1 is provided with a thermal conductive tray 2. The thermal conductive tray is made of 403 stainless steel, and other materials that can conduct heat can also be used, such as 304 stainless steel, which is superior than 403 stainless steel. The shell 1 is provided with an installation chamber for accommodating a heating device and a control circuit board 4. The control circuit board 4 is mainly used to control heating gears and time. The heating device is set in the installation chamber, fixedly connected to the shell 1, electrically connected to the control circuit board 4, and connected to the thermal conductive tray 2. After the heating device is powered on, it can transmit heat to the thermal conductive tray 2, such that the thermal conductive tray 2 can heat a water container placed on a heating surface of the thermal conductive tray 2.

The touch sensing switch 3 includes a touch sensing area 31 and an induction element 32, and the induction element 32 can be a flat top spring connected between the touch sensing area 31 and the control circuit board 4. The touch sensing area 31 is disposed on the shell 1, integrated with the shell 1 and formed with the shell 1 in the same molding process. The induction element 32 is disposed between the touch sensing area 31 and the control circuit board 4. One end of the induction element 32 is in connected to the touch sensing area 31, and the other end is electrically connected to the control circuit board 4. Overall, by using the touch sensing switch 3, the mechanical operation of the switch buttons and noise are reduced, and the touch sensing switch 3 is waterproof and leakage proof, thus can reduce switch damage. This not only increases the intelligent effect of the intelligent cup warmer, but also extends the service life of the intelligent cup warmer. The intelligent cup warmer can also be provided with an LED light, which produces a backlight effect. Depending on the button, color emitted by the LED light varies. An LED light 9 is set between the control circuit board 4 and the touch sensing area 31, an emitting side of the LED light 9 faces the touch sensing area 31 to form a different backlight effect when pressing the touch sensing switch 3.

In this embodiment, the thermal conductive tray 2 of the intelligent cup warmer is set at 5.3 inches, compared with 4.3 inches of the existing tray in the market, the thermal conductive tray 2 of the intelligent cup warmer in this embodiment can accommodate a cup with a larger size, such as an 18 ounce mug and a mug with a flat bottom. A heating area of the tray of the existing cup warmer in the market is generally 3.5 inches, and a heating area of the thermal conductive tray 2 of the intelligent cup warmer in this embodiment is 4.28 inches, resulting a larger heating area of the intelligent cup warmer, allowing users to use multiple sizes of water containers to be heated.

The intelligent cup warmer also includes a power cord 10, a plurality of anti slip pads 111 and a plurality of heat dissipation holes 112. One end of the power cord 10 is connected to the control circuit board 4, and a plug is set on the other end of the power cord 10. The anti slip pads 111 and the heat dissipation holes 112 are arranged at a bottom of the bottom shell 11, and the anti slip pads 111 are arranged at the four corners of the bottom shell 11. The anti slip pads 111 raise the intelligent cup warmer, so that when the intelligent cup warmer is placed on a platform, there is a gap between the intelligent cup warmer and the platform. When a heating plate 62 emits heat, the heat emitted by the heating plate 62 disperses through the heat dissipation holes 112 and the gap.

In this embodiment, the intelligent cup warmer also includes a temperature detection device 8. The temperature detection device Bis used to detect a temperature of the heating device. The control circuit board 4 is used to control the temperature of the heating device based on the temperature detected by the temperature detection device 8. The temperature detection device 8 includes a temperature detection head, an end of the temperature detection head is connected to the heating device, and the other end of the temperature detection device 8 is electrically connected to the control circuit board 4. In this embodiment, the temperature detection device 8 preferably uses an NTC temperature sensor, the NTC temperature sensor can provide a higher electric resistance for the thermal resistor at low temperatures. It can be understood, according to a RT table of the NTC temperature sensor, as the temperature increases, the electric resistance gradually decreases. Due to the significant change in electric resistance per degree Celsius, small changes will accurately reflect, and thus an output of NTC thermal resistor is nonlinear due to their exponential properties, but it can be linearized according to its application. An effective operating temperature of the temperature detection device 8 can be 150° C., with endurance of high temperature and less prone to circuit burnout.

In this embodiment, the heating device includes an installation frame 61 and a heating plate 62, and the installation frame 61 is fixedly connected to the shell 1. The installation frame 61 is provided with a first installation opening 611, and the heating plate 62 is clamped and arranged inside the first installation opening 611. The heating plate 62 is electrically connected to the control circuit board 4, and the heating plate 62 is connected to a lower surface of the thermal conductive tray 2. This arrangement reasonably sets the installation chamber, making a assembly of the intelligent cup warmer more reasonable and simple. After being powered on, the heating plate 62 can transmit heat to the thermal conductive tray 2. The heating plate 62 can include a PET heating plate, a PI heating plate, a silicone heating plate, an aluminum plate heating plate, an epoxy resin heating plate, an epoxy resin electric heating plate, a PTC heating plate, a PTC heating board, a graphene heating plate, or a carbon fiber heating plate. In this embodiment, the heating plate 62 preferably uses the PTC heating board, for the benefits are as follows: it heats quickly and the aluminum plate is more compact and has higher thermal efficiency; the healthy and environmentally friendly adhesive free bonding is healthier; ultra long and durable usage without oxidation, with a service life of up to 6000 hours; the thermal efficiency of the PTC heating board is up to 99%, and the beverage can be quickly heated by users, resulting a better user experience. In this embodiment, the heating plate 62 can heat the thermal conductive tray 2 to 149° F. (65° C.), 230° F. (110° C.), 266° F. (130° C.), 302° F. (150° C.), 338° F. (170° C.), corresponding to a temperatures of liquid of cup heated by the thermal conductive tray 2 can be 113° F. (45° C.), 131° F. (55° C.), 140° F. (60° C.), 149° F. (65° C.), 158° F. (70° C.).

In this embodiment, the heating plate 62 is electrically connected to the control circuit board 4 through a first wire 51 and a second wire 52. A first end of the first wire 51 and a first end of the second wire 52 are detachably connected to the control circuit board 4. Under the circumstances of damage to the control circuit board 4 or the heating plate 62, it is convenient to replace the control circuit board 4 or the heating plate 62, and the intelligent cup warmer can be recycled and used again. A second end of the first wire 51 is connected to the heating plate 62, and a second end of the second wire 52 is electrically connected to the temperature detection device 8. The heating plate 62 is electrically connected to the control circuit board 4 through the first wire 51, and the control circuit board 4 is electrically connected to the temperature detection device 8 through the second wire 52.

In this embodiment, two sides of the first installation opening 611 is provided with clamping pieces 612, and a positioning groove 613 is formed between the two clamping pieces 612. The heating plate 62 is provided with at least one positioning protrusion 621. When the installation frame 61 is fixedly connected to the shell 1 and the positioning protrusion 621 is set in the positioning groove 613, the clamping pieces 612 press the heating plate 62 onto the thermal conductive tray 2 tightly.

In this embodiment, both the first end of the first wire 51 and the first end of the second wire 52 are provided with a connector 5, and the connector 5 includes a female terminal 53 and a male terminal 54. The female terminal 53 is fixed on the control circuit board 4, the male terminal 54 is set at the first end of the wire 51 or 52, and the female terminal 53 and the male terminal 54 are detachably connected. Alternatively, the female terminal 53 can be fixed at the first end of the first wire 51 or the second wire 52, and the male terminals 54 can be installed on the control circuit board 4. The female terminal 53 and the male terminal 54 can be detachably connected by using wiring terminals, in order to facilitate the connection and disassembly of the first wire 51 and the second wire 52.

In this embodiment, there are a plurality of first installation holes 614 disposed on an edge of the installation frame 61, a plurality of first installation pillar 13 corresponding to the first installation holes 614 are provided on the shell 1, and a plurality of second installation holes 131 corresponding to the first installation holes 614 are provided on the first installation pillar 13 respectively. The first installation holes 614 are connected to the corresponding second installation holes 131 through a plurality of bolts to fix the installation frame 61 on the shell 1. The installation frame 61 is configured to fix and connect the thermal conductive tray 2. This setting facilitates the assembly and fixation of the intelligent cup warmer.

In this embodiment, the shell 1 includes a bottom shell 11 and an upper shell 12. The bottom shell 11 is provided with a plurality of second installation pillars 14, and the upper shell 12 is provided with an installation groove 121 corresponding to the second installation pillar 14. The installation groove 121 is clamped with the second installation pillar 14 to ensure that the bottom shell 11 and the upper shell 12 cover each other. The upper shell 12 is provided with a second installation opening 122, and the thermal conductive tray 2 is installed at the second installation opening 122. This facilitates the assembly, fixation, installation, and disassembly of intelligent cup warmers.

In this embodiment, a touch sensing area 31 includes a temperature control sensing key area 311 and a temperature timing sensing key area 312. The sensing element 32 includes a temperature control sensing element 321 and a timing sensing element 322. The temperature control sensing element 321 is arranged between the temperature control sensing key area 311 and the control circuit board 4, and one end of the temperature control sensing element 321 connects with the temperature control sensing key area 311. The other end of the temperature control sensing element 321 is arranged on the control circuit board 4. The timing sensing element 322 is arranged between the temperature timing sensing key area 312 and the control circuit board 4. One end of the timing sensing element 322 is in contact with the temperature timing sensing key area 312, and the other end of the timing sensing element 322 is arranged on the control circuit board 4. In this embodiment, the temperature timing sensing key 312 has three automatic shutdown functions for there different heating time, such as two hours, four hours, and eight hours. The temperature timing sensing key area 312 adjusts the temperature timing based on the number of touches. The default heating automatic shutdown time for the product is 4 hours, and the other two time options are the selection of constant temperature for 2 hours and 8 hours. For example, pressing the temperature timing sensing key area 312 means 4 hours at a first time, press it again means 8 hours, press it the third time means 2 hours, press the button the fourth time means turn off timer, press the button the fifth time for 4 hours, and this cycles in sequence. The temperature timer sensing button 312 provides consumers with more heating time options. In the embodiment, there are 5 heating gears with five different heating temperatures ranging from 110° C. to 170° C., such as the temperature of 5 heating gears can be set to 110° C., 130° C., 150° C., 165° C., and 170° C. Temperature increases after pressing the temperature control sensing key area 312, and after reaching the maximum temperature, a user presses it again to turn off the machine, and then presses it again to turn on the machine, and it cycles accordingly. This temperature setting makes it easier for users to heat different drinks, such as hot chocolate, coffee, tea, milk, water and other drinks, within the temperature range from 45° C. to 70° C. or 113° F. to 158° F. Compare with the existing devices in the market only having one or three temperature settings, in this embodiment, the intelligent cup warmer has five different temperature settings, with more and higher temperature selection settings for users to choose. Furthermore, the highest heating temperature of the existing cup warmer for beverage is 131° F. (55° C.), and the intelligent cup warmer of this embodiment can be increased to 158° F. (70° C.). The upper limit temperature setting of the intelligent cup warmer of this embodiment has been increased, and the maximum temperature can be adjusted to 158° F. (70° C.), allowing drinks to be heated and maintained at a higher temperature.

In can be seen that, the structure of the intelligent cup warmer of this embodiment is compact and simple. Compared to the existing cup warmers, the intelligent cup warmer of this embodiment with the touch sensing switch 3 is preferable in waterproof and intelligence. It also has three automatic shutdown functions for there different heating times. and five different temperature setting, and there is also the LED light 9 for emitting lights during temperature adjusting, providing a better user experience.

As described above, one or more embodiments are provided in conjunction with the detailed description, The specific implementation of the present disclosure is not confirmed to be limited to that the description is similar to or similar to the method, the structure and the like of the present disclosure, or a plurality of technical deductions or substitutions are made on the premise of the conception of the present disclosure to be regarded as the protection of the present disclosure.

What is claimed is:

1. An intelligent cup warmer, comprising a shell, a control circuit board, a heating device a thermal conductive tray, and a touch sensing switch, wherein the thermal conductive tray is disposed on an upper side of the shell, the shell comprises an installation chamber for accommodating the heating device and the control circuit board, an upper surface of the thermal conductive tray is configured to heat cups, a bottom surface of the thermal conductive tray are connected the heating device, the touch sensing switch comprises a touch sensing area disposed on the shell, integrated with the shell and formed with the shell in the same molding process, the induction element is disposed between the touch sensing area and the control circuit board, one end of the induction element is in connected to the touch sensing area, and the other end is electrically connected to the control circuit board.

2. The intelligent cup warmer according to claim 1, wherein the intelligent cup warmer comprises an LED light disposed between the control circuit board and the touch sensing area and configured for emitting induction lights, the induction element is a flat top spring surrounding the LED light and connected between the touch sensing area and the control circuit board.

3. The intelligent cup warmer according to claim 1, wherein the heating device is fixedly connected to the shell, electrically connected the control circuit board, contacted with the bottom surface of the thermal conductive tray, the heating device is configured to transmit heat to the thermal conductive tray.

4. The intelligent cup warmer according to claim 3, wherein the intelligent cup warmer further comprises a temperature detection device configured to detect a temperature of the heating device, the control circuit board is configured to control a temperature of the heating device based on the temperature detected by the temperature detection device, the temperature detection device comprises a temperature detection head connected to the heating device, and the temperature detection device is electrically connected to the control circuit board.

5. The intelligent cup warmer according to claim 4, wherein the temperature detection device comprises an NTC temperature sensor.

6. The intelligent cup warmer according to claim 4, wherein the heating device comprises a installation frame and a heating plate, and the installation frame is fixedly connected to the shell, the installation frame is provided with a first installation opening, and the heating plate is clamped and arranged inside the first installation opening, the heating plate is electrically connected to the control circuit board, and the heating plate is connected to a lower surface of the thermal conductive tray for transmitting heat to the thermal conductive tray.

7. The intelligent cup warmer according to claim 6, wherein the heating plate comprises a PTC heating plate.

8. The intelligent cup warmer according to claim 6, wherein the heating plate is electrically connected to the control circuit board through a first wire and a second wire, a first end of the first wire and a first end of the second wire are detachably connected to the control circuit board, a second end of the first wire is connected to the heating plate, a second end of the second wire is electrically connected to the temperature detection device, the heating plate is electrically connected to the control circuit board through the first wire, and the control circuit board is electrically connected to the temperature detection device through the second wire.

9. The intelligent cup warmer according to claim 6, wherein two sides of the first installation opening is provided with clamping pieces, and a positioning groove is formed between the two clamping pieces, the heating plate is provided with at least one positioning protrusion, when the installation frame is fixedly connected to the shell and the positioning protrusion is disposed in the positioning groove, and the clamping pieces press the heating plate onto the thermal conductive tray tightly.

10. The intelligent cup warmer according to claim 9, wherein both the first end of the first wire and the first end of the second wire are provided with a connector, and the connector includes a female terminal and a male terminal, the female terminal is fixed on the control circuit board, the male terminal is set at the first end of the wire, and the female terminal and the male terminal are detachably connected.

11. The intelligent cup warmer according to claim 6, wherein a plurality of first installation holes are disposed on the installation frame, a plurality of first installation pillar corresponding to the first installation holes are provided on the shell, and a plurality of second installation holes corresponding to the first installation holes are provided on the first installation pillar respectively, the first installation holes are connected to the corresponding second installation holes through a plurality of bolts to fix the installation frame on the shell, and the installation frame is configured to fix and connect the thermal conductive tray.

12. The intelligent cup warmer according to claim 6, wherein the shell comprises a bottom shell and an upper shell, the bottom shell is provided with a plurality of second installation pillars, the upper shell is provided with an installation groove corresponding to the second installation pillar, the installation groove is clamped with the second installation pillar to ensure the bottom shell and the upper shell cover each other, the upper shell is provided with a second installation opening, and the thermal conductive tray is installed at the second installation opening.

13. The intelligent cup warmer according to claim 12, wherein a plurality of heat dissipation holes is provided on a bottom of the bottom shell.

14. The intelligent cup warmer according to claim 13, wherein a plurality of anti slip pads are provides on a bottom of the bottom shell, the anti slip pads are configured to raise the intelligent cup warmer, so that when the intelligent cup warmer is placed on a platform, there is a gap between the intelligent cup warmer and the platform, and when a heating plate emits heat, the heat emitted by the heating plate disperses through the heat dissipation holes and the gap.

15. The intelligent cup warmer according to claim 1, wherein the touch sensing area comprises a temperature control sensing key area and a temperature timing sensing key area, the sensing element comprises a temperature control sensing element and a timing sensing element, the temperature control sensing element is arranged between the temperature control sensing key area and the control circuit board, and one end of the temperature control sensing element connects with the temperature control sensing key area, the other end of the temperature control sensing element is arranged on the control circuit board, the timing sensing element is arranged between the temperature timing sensing key area and the control circuit board, one end of the timing sensing element is in contact with the temperature timing sensing key area, and the other end of the timing sensing element is arranged on the control circuit board.

16. The intelligent cup warmer according to claim 15, wherein the intelligent cup warmer comprises five different heating temperatures ranging from 110° C. to 170° C.

17. The intelligent cup warmer according to claim 16, wherein the five different heating temperatures are 110° C., 130° C., 150° C., 165° C., and 170° C.

18. The intelligent cup warmer according to claim 15, wherein the intelligent cup warmer comprises three automatic shutdown functions for there different heating times, the three different heating times are two hours, four hours and eight hours.

19. The intelligent cup warmer according to claim 1, wherein the intelligent cup warmer comprises a power cord, one end of the power cord is connected to the control circuit board, and a plug is disposed on the other end of the power cord.
